(19) United States
(12) Patent Application Publication
(10) Pub. No.: US 2025/0271043 A1
(43) Pub. Date: Aug. 28, 2025

(54) ELECTRICAL CONNECTOR, CALIPER BODY, BRAKE CALIPER ASSEMBLY, WEAR INDICATOR

(71) Applicant: BREMBO S.p.A., Curno (Bergamo) (IT)

(72) Inventors: Alberto BOSIS, Curno (Bergamo) (IT); Lucrezia LIGARI, Curno (Bergamo) (IT)

(73) Assignee: BREMBO S.p.A., Curno (Bergamo) (IT)

(21) Appl. No.: 18/857,855

(22) PCT Filed: Apr. 21, 2023
(86) PCT No.: PCT/IB2023/054101

§ 371 Date: Oct. 18, 2024

(30) Foreign Application Priority Data
Apr. 22, 2022 (IT) 102022000008030

(51) Int. Cl. F16D 66/02; F16D 55/00; F16D 55/2265

(52) U.S. Cl. CPC F16D 66/021; F16D 55/2265; F16D 2055/0016

(57) ABSTRACT

An electrical connector for a wear sensor has a connector body made of an electrically insulating material and defining a seat for a plug or a socket for electrically connecting the wear sensor to a wear detection circuit, a hook portion configured to be coupled to a tooth of a caliper body, the hook portion being made in one piece with the connector body, and at least one elastic interference portion overhangingly projecting from the connector body. Each elastic interference portion is elastically bendable between a resting configuration and a maximum interference configuration so as to slide against a caliper body surface opposite to the tooth by bending from the resting configuration until the elastic interference portion blocks by interference against the caliper body surface in the maximum interference configuration by tightening a caliper body wall from opposite sides between the hook portion and each elastic interference portion.

### FIELD OF THE INVENTION

The present invention relates to an electrical connector, as well as to a caliper body, a brake caliper assembly, and a wear indicator.

### BACKGROUND ART

In the context of disc brakes for vehicles, electrical wear indicators employing a sensor associated with a brake caliper pad are known. These indicators transmit the signal from the sensor, which is indicative of pad wear, through an electrical cable ending in a connector, which in turn is connected, by means of a corresponding electrical contact element and another electrical cable, to a wear detection circuit which allows, for example, displaying the wear status of the pad on the vehicle dashboard.

In order to prevent the electrical connector and/or the cables leading off therefrom or to be connected thereto from somehow creating problems of hindrance during the assembly of the caliper body and making the assembly thereof on the hub holder of the vehicle more laborious, solutions have been suggested, in which an elastic metal connection plate fixed to the caliper body and to which the electrical connector is connected via coupling means is employed.

In some solutions, as known from document WO03046403, for example, the elastic metal connection plate is fixed to the caliper body by means of a threaded screw which is threaded into a seat obtained in the elastic metal connection plate as well as into a hole obtained in the caliper body. This type of solution makes it necessary to perform machining operations on the caliper body, as well as on the metal plate, to make the hole in the metal plate, the hole in the caliper body, as well as the threading in the hole in the caliper body. Although this solution fully achieves its purpose, it requires relatively long machining times and therefore high costs.

In other solutions, as known from document WO2006001036, for example, the plate is connected by engagement in a V-shaped seat obtained on the caliper body, with a tongue of the metal plate interlocked between two opposite walls of the V-shaped seat without the need for further machining operations of the caliper body to connect the plate to the caliper body. While this solution allows reducing the cost of preparing the caliper body, it also employs a large number of components as well as a large number of machining operations on the connector, in particular on the metal plate which must be sheared and bent before being used, as well as a large number of steps to assemble the electrical connector to the caliper body, such as correctly inserting the elastic metal plate into the respective engagement seat, connecting the electrical connector body to the elastic metal plate, and finally forcing the elastic metal plate onto the caliper body, for example.

Therefore, the need is strongly felt in this field for a caliper body connector coupling system which allows reducing the time and cost of manufacturing the connector and the caliper body, as well as the time and cost of assembling the connector to the caliper body, compared to the prior art.

### SOLUTION

It is the object of the present invention to provide an electrical connector, as well as a caliper body, a brake caliper assembly, and a wear indicator which allow solving the complained problems of the prior art.

This and other objects and advantages are achieved by a connector according to claim 1, a caliper body according to claim 9, a brake caliper assembly according to claim 14, a wear indicator according to claim 15.

Some advantageous embodiments are the subject of the dependent claims.

By virtue of the suggested solutions, it is possible to ensure a secure coupling between a connector and a caliper body, avoiding finishing and drilling machining operations on the caliper body, thus reducing the components of the electrical connector compared to the prior art.

By virtue of the suggested solutions, a reliable and easy connection of the connector to the caliper body can be ensured.

By virtue of the suggested solutions, it is possible to connect the electrical connector to the caliper body in a single assembly step, connecting the electrical connector directly to the caliper body and avoiding the use of further connecting elements between the two parts.

By virtue of the suggested solutions, it is possible to correctly position the electrical connector to the caliper body automatically, due to the shape of the connector and the shape of the caliper body, either manually or by means of pressure tools.

### DRAWINGS

Further features and advantages of the electrical connector, the caliper body, the brake caliper assembly, and the wear indicator will become apparent from the description provided below of preferred embodiments thereof, given by way of non-limiting indication, with reference to the accompanying drawings, in which:

FIG. 1 is an axonometric view of a brake caliper assembly comprising a caliper body to which an electrical connector for a wear sensor is connected, according to the present invention;

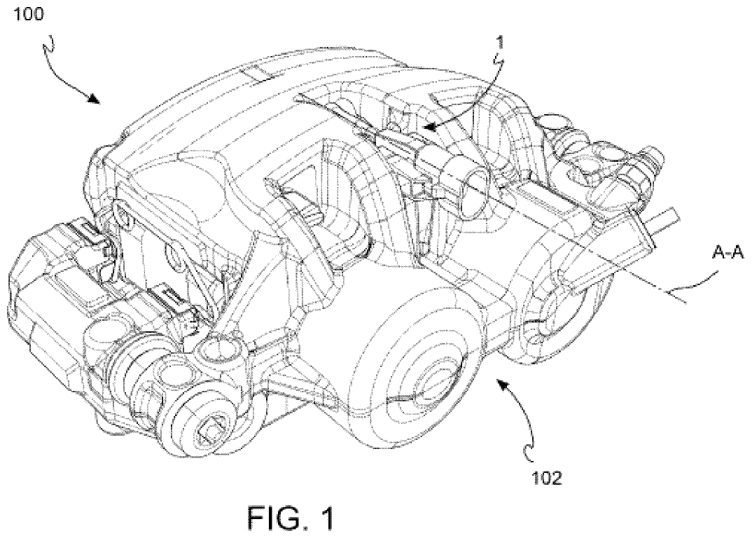

FIG. 2 is an exploded axonometric view of the electrical connector according to the present invention, and the caliper body according to the present invention and shown in FIG. 1, in which the electrical connector connected to a wear sensor through an electrical cable can be seen, in which the hook portion made in one piece with the connector body, made of an electrically insulating material and compatible with brake fluid is shown;

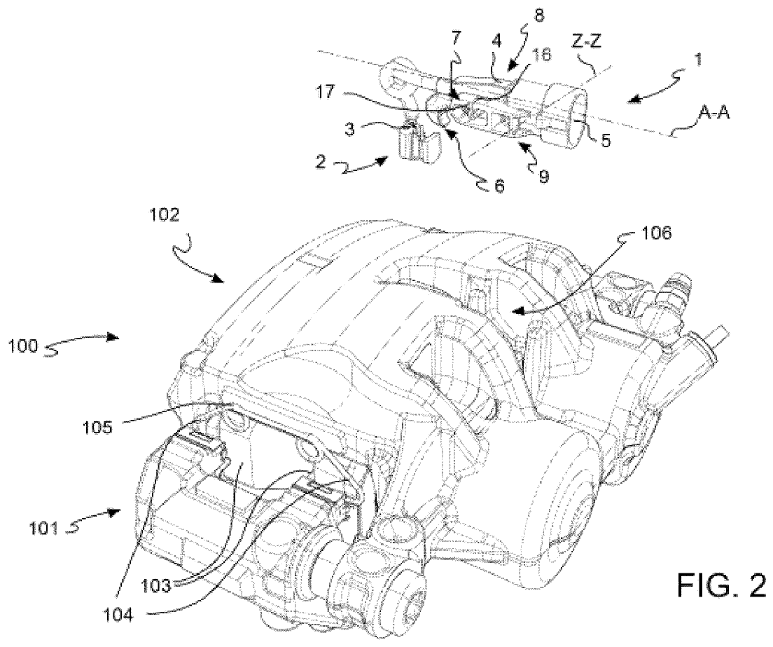

FIG. 3 is an axonometric view of a detail of FIG. 1, in which at least one elastic interference portion can be seen, abutting by interference against a caliper body surface opposite to a caliper body tooth to which the hook portion of the electrical connector is coupled;

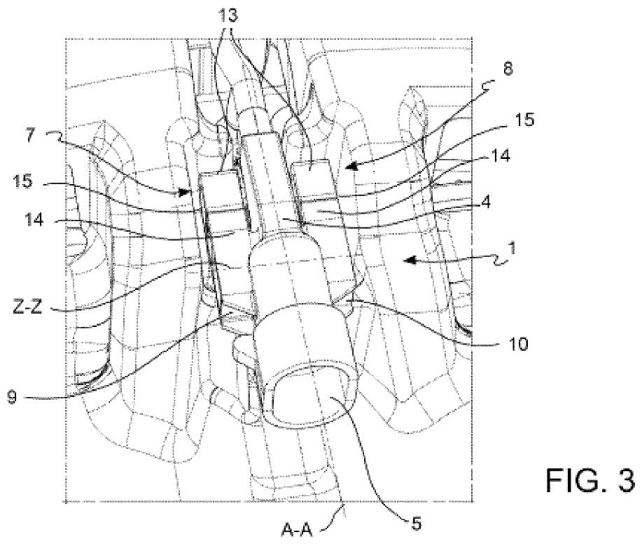

FIG. 4 shows a detail of the caliper body of FIG. 2, in which an axonometric view of the caliper body portion to which the electrical connector can be connected is shown, in which the wall of the caliper body having a U-shaped profile delimited by two radially protruding portions of the wall, connected by a hollow portion, can be seen, in which the hook portion of the electrical connector is insertable into the U-profile to couple the caliper body tooth, and the at least one elastic interference portion, by abutting against the caliper body surface opposite to the tooth, bends elastically by sliding over the caliper body surface until it blocks by interference;

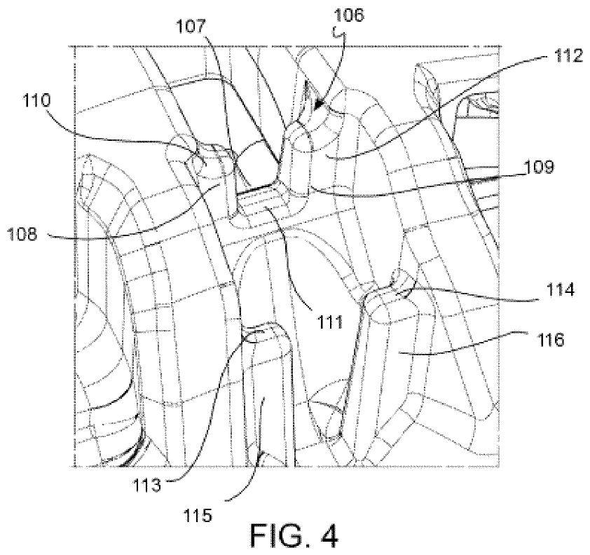

FIG. 5 is a partially-sectioned axonometric view taken along the section plane B-B in FIG. 1 of the caliper body and the electrical connector in FIG. 1, in which the hook portion coupled like an undercut to the tooth of the caliper body can be seen, in which the hook portion is substantially counter-shaped to the profile of the tooth of the caliper body;

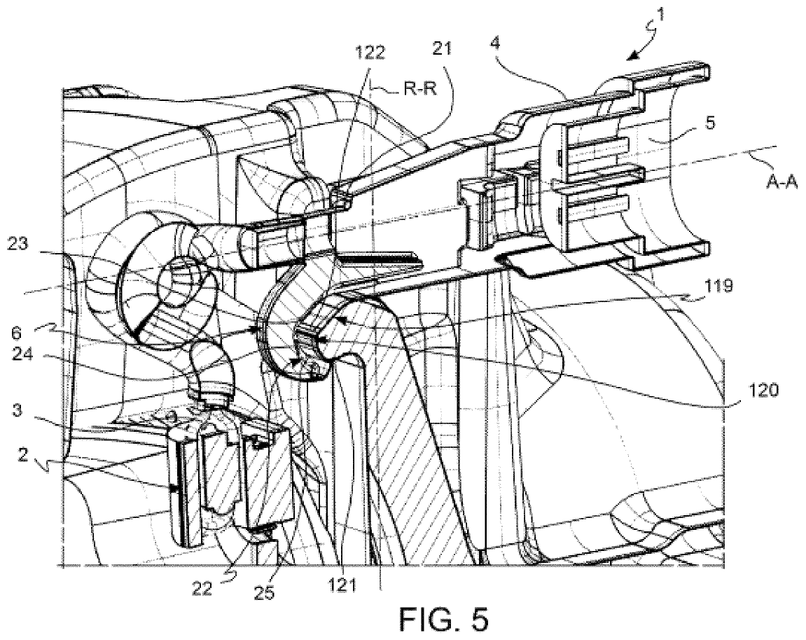

FIG. 6 is a partially-sectioned axonometric view taken along the section plane C-C in FIG. 1 of the caliper body and the electrical connector in FIG. 1, in which the at least one elastic interference portion bent in a maximum interference configuration and the at least one support portion of the electrical connector resting on the caliper body, at a support portion of the caliper body, can be seen;

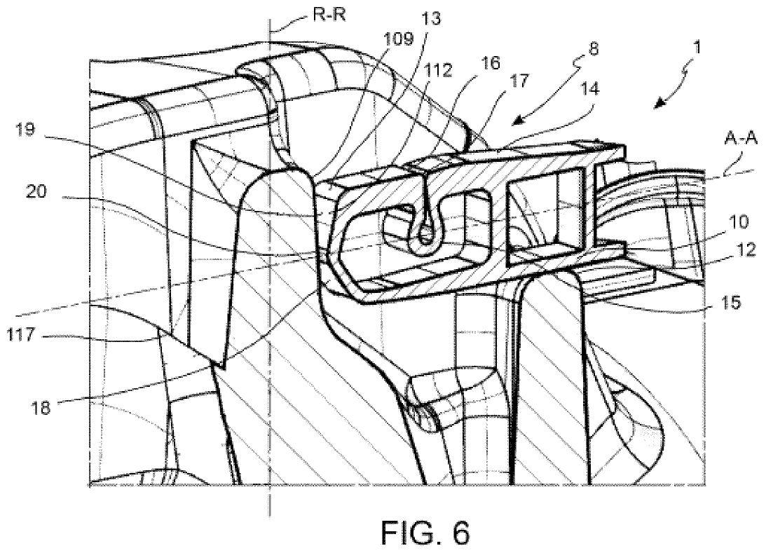

FIG. 7 is a side view of the electrical connector and the partially-sectioned caliper body, to better illustrate the electrical connector, in which the hook portion coupled like an undercut to the caliper body tooth and the elastic interference portion bent in a maximum interference configuration against the caliper body surface opposite to the tooth, and the connector support portion can be seen, in which a caliper body separation line passing through the caliper body tooth can be seen;

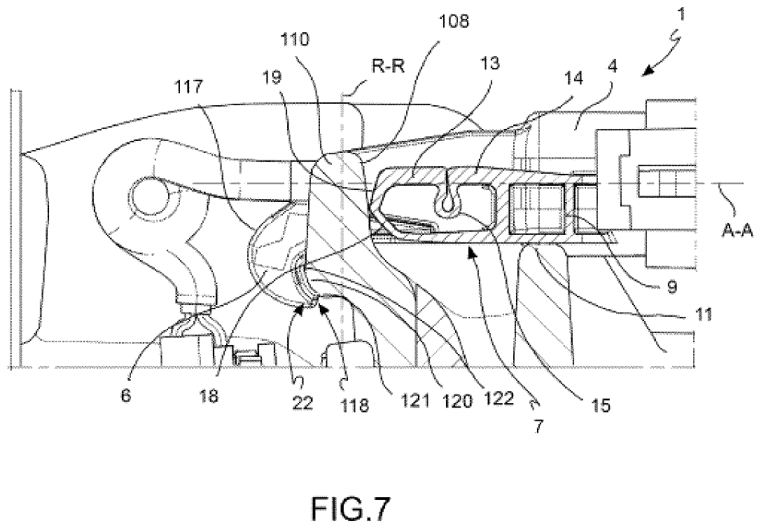

FIG. 8 is an axonometric view of a brake caliper assembly comprising a caliper body to which an electrical connector for a wear sensor is connected, according to the present invention, in which the electrical connector comprises a flat spring to be connected to the caliper body;

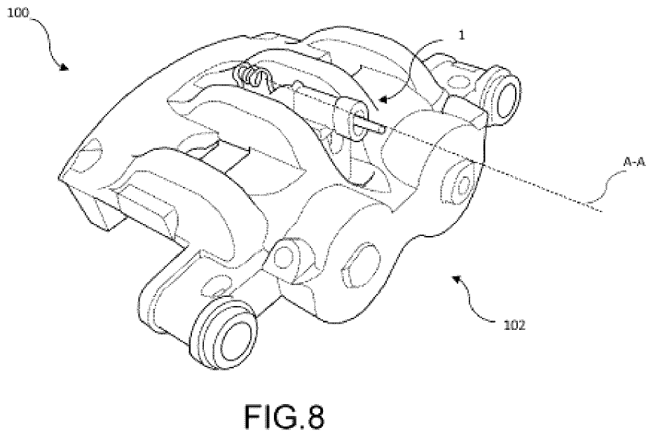

FIG. 9 is an exploded axonometric view of the electrical connector according to the present invention and the caliper body according to the present invention as shown in FIG. 8, in which the electrical connector connected to a wear sensor through an electrical cable can be seen, in which the hook portion made in one piece with the connector body, made of an electrically insulating material and compatible with brake fluid, is shown, and in which the flat spring, preferably made of steel, connectable by interlocking or co-molding in the connector body, is shown;

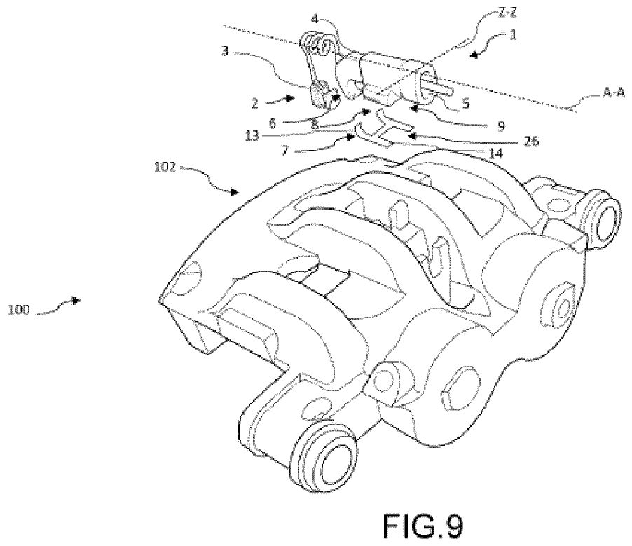

FIG. 10 is in a partially-sectioned axonometric view of FIG. 8 of the caliper body and electrical connector in FIG. 8, in which the at least one elastic interference portion, in the form of a metal tongue of the flat spring, bent in a maximum interference configuration and the at least one support portion of the electrical connector resting on the caliper body, at a support portion of the caliper body, can be seen;

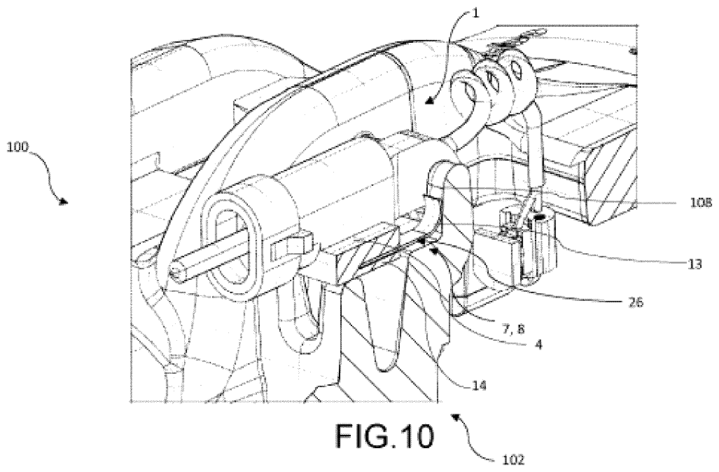

FIG. 11 is a partially-sectioned axonometric view of the caliper body and electrical connector in FIG. 8, in which the hook portion coupled like an undercut to the caliper body tooth can be seen, in which the hook portion is at least partially counter-shaped to the caliper body tooth profile.

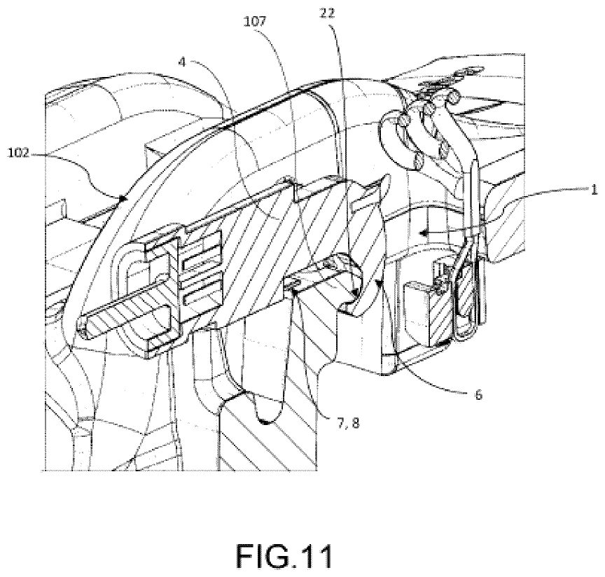

### DESCRIPTION OF SOME PREFERRED EMBODIMENTS

According to a general embodiment, an electrical connector for a wear sensor 2 is indicated by reference numeral 1 as a whole.

The electrical connector 1 comprises a connector body 4 made of an electrically insulating material and defining a seat 5 for a plug or a socket to electrically connect the wear sensor 2 to a wear detection circuit.

Advantageously, the electrical connector 1 comprises a hook portion 6 in the shape of a hook, where said hook portion 6 is configured to be coupled to a tooth 107 of the caliper body 102, where the hook portion 6 is made in one piece with said connector body 4.

Advantageously, the electrical connector 1 comprises at least one elastic interference portion 7, 8 overhangingly projecting from the connector body 4.

Advantageously, each elastic interference portion 7, 8 is elastically bendable between a resting configuration and a maximum interference configuration so as to slide against a caliper body surface 108 opposite to said tooth 107 by bending from said resting configuration until it blocks by interference against the caliper body surface 108 in said maximum interference configuration by tightening a caliper body wall 106 of the caliper body 102 from opposite sides between the hook portion 6 and each elastic interference portion 7, 8.

By virtue of the suggested solution, it is possible to manufacture an electrical connector directly connectable to the caliper body, at least directly by means of a portion of the connector body without using engagement or coupling fixing elements, such as metal plates.

By virtue of the suggested solution, it is possible to reduce the number of components required for reliably fixing the electrical connector 1 to the caliper body 102.

According to an embodiment, the electrical connector 1 comprises at least one support portion 9, 10 made in one piece with said connector body 4, where said at least one elastic interference portion 7, 8 overhangingly projects from said at least one support portion 9, 10.

According to an embodiment, said support portion 9, 10 comprises a preferably flat connector support surface 11, 12 to be supported against the caliper body 102 so as to block each elastic interference portion 7, 8 bent in said maximum interference configuration and interposed between said caliper body surface 108, 109 and said support portion 9, 10.

By virtue of the provision of at least one support portion 9, 10 of the connector body 4, it is possible to simplify the correct positioning of the electrical connector 1 with respect to caliper body 106 making the caliper body and the electrical connector 1 so that when the support portion 9, 10 abuts against the caliper body, the electrical connector 1 is correctly coupled to the caliper body tooth with the elastic interference portion in the maximum interference configuration interposed between the support portion 9, 10 and the caliper body surface.

According to an embodiment, each elastic interference portion 7, 8 is made in one piece with said connector body 4.

According to an embodiment, said elastic interference portion 7, 8 is made by molding a polymer material. According to an embodiment, said connector body 4 is made of a thermoplastic material. According to an embodiment, said connector body 4 is made of polyamide. According to an embodiment, said connector body 4 is made of nylon 66 or polyamide 66.

By virtue of the electrical connector 1, in which the connector body 4 is made by molding integrally to the hook portion 6 and the at least one elastic interference portion, it is possible to couple the connector body 4 directly to the caliper body 102, reducing the number of components to be assembled to connect the electrical connector to the caliper body compared to the prior art.

In an embodiment, the electrical connector 1 comprises a flat spring 26, where the flat spring 26 comprises said at least one elastic interference portion 7, 8. In an embodiment, the flat spring 26 comprises the first elastic interference portion 7 and the second elastic interference portion 8.

In an embodiment, the flat spring 26 is made of metal, preferably steel.

In an embodiment, the at least one elastic interference portion 7, 8 is at least one metal tongue of the flat spring 26. In an embodiment, the first elastic interference portion 7 and the second elastic interference portion 8 are a first metal tongue 27 and a second metal tongue 28 of the flat spring 26, respectively.

In an embodiment, the flat spring 26 is connected by interlocking in a spring seat obtained in the connector body 4 so that the at least one elastic interference portion 7, 8 overhangingly projects from the connector body 4. In an embodiment, the spring seat is at least one slot obtained in the connector body 4 and adapted to accommodate a respective portion of the flat spring connection. In an embodiment, the flat spring 26 is partially embedded in the polymer material of the connector body 4.

In an embodiment, the flat spring 26 is connected to the connector body 4 by interlocking so that the at least one elastic interference portion 7, 8 overhangingly projects from the connector body 4.

In an embodiment, the flat spring 26 is connected to the connector body 4 by co-molding so that the at least one elastic interference portion 7, 8 overhangingly projects from the connector body 4.

In an embodiment, the flat spring 26 is made by bending and blanking a metal sheet so as to form the at least one elastic interference portion 7, 8 with at least one metal tongue.

By virtue of the provision of a flat spring 26 defining the elastic interference portion 7, 8, it is possible to make an electrical connector 1 constrainable to the caliper body by means of metal portions, which are highly reliable at high temperatures and very wear-resistant over time.

According to an embodiment, each elastic interference portion 7, 8 comprises a distal portion 13 adapted to slide on said caliper body surface 108, 109 until it blocks on said caliper body surface 108, 109 when said elastic interference portion 7, 8 is in said maximum interference configuration. In an embodiment, the distal portion 13 is a bent portion of the respective metal tongue of the flat spring 26 which forms the respective elastic interference portion 7, 8.

According to an embodiment, each elastic interference portion 7, 8 comprises a proximal portion 14 connected to said connector body 4. In an embodiment, the proximal portion 14 is a connection portion of the metal tongue of the flat spring 26 which forms the respective elastic interference portion 7, 8, which is adapted to be connected, for example by interlocking or co-molding, to the connector body 4.

According to an embodiment, each elastic interference portion 7, 8 comprises a central portion 15 joined to said distal portion 13 and said proximal portion 14, where said central portion 15 is U-or V-shaped defining a fulcrum about which said distal portion 13 elastically rotates with respect to said proximal portion 14 between said resting configuration and said maximum interference configuration.

According to an embodiment, each elastic interference portion 7, 8 comprises a laminar body of variable thickness. According to an embodiment, the laminar body of each elastic interference portion 7, 8 forms a closed profile by delimiting an open cavity along a direction, coincident with the direction of the axis about which the elastic interference portion 7, 8 bends and/or flexes, preferably coincident with or parallel to the lateral direction Z-Z.

According to an embodiment, each elastic interference portion 7, 8 comprises an abutment portion 16 which joins the central portion 15 and the distal portion 13. According to an embodiment, each elastic interference portion 7, 8 comprises a counter-abutment portion 17, which joins the central portion 15 and the proximal portion 14.

According to an embodiment, said abutment portion 16 faces said counter-abutment portion 17.

According to an embodiment, the distal portion 13 is configured to rotate elastically about the central portion 15 until the abutment portion 16 abuts against the counter-abutment portion 17 thus preventing further elastic rotations of the distal portion 13 with respect to the proximal portion 14.

According to an embodiment, said abutment portion 16 and said counter-abutment portion 17 comprise an abutment surface and a counter-abutment surface, respectively. According to an embodiment, the abutment surface and the counter-abutment surface are oriented with respect to each other by an angle between 45 and 20 degrees, preferably between 40 and 35 degrees. According to an embodiment, in said maximum interference configuration, said abutment surface and said counter-abutment surface are in contact at least at one point and/or are oriented parallel to each other. According to an embodiment, in said resting configuration, the abutment surface and the counter-abutment surface are flat surfaces.

According to an embodiment, between said resting configuration and said maximum interference configuration, each distal portion 13 rotates with respect to the respective proximal portion 14 by an interference angle between 45 degrees and 20 degrees, preferably between 40 degrees and 35 degrees.

According to an embodiment, each distal portion 13 has a convex profile so as to facilitate the sliding against the caliper body surface 108, 109 by rotating the distal portion 13 about the central portion 15. According to an embodiment, each distal portion 13 has at least a first sliding section 18 joined to a second sliding section 19 by a sharp portion 20 configured to tighten by interference on the caliper body surface 108, 109.

According to an embodiment, said connector body 4 mainly extends along an extension axis, defining an axial direction A-A, between a wear sensor side connection end 21 and said plug or socket seat 5 for connecting the wear sensor 2 to a wear detection circuit.

According to an embodiment, each elastic interference portion 7, 8 mainly extends along a direction parallel to said axial direction A-A.

According to an embodiment, said at least one elastic interference portion 7, 8 comprises a first elastic interference portion 7 and a second elastic interference portion 8 laterally connected to said connector body 4 by two diametrically opposite parts of the connector body 4 along a lateral direction Z-Z orthogonal and/or incident to said axial direction A-A.

According to an embodiment, said first elastic interference portion 7 and said second elastic interference portion 8 overhangingly project from said connector body 4 along directions parallel to said extension axis A-A by elastically bending about a bending axis parallel to said lateral direction Z-Z.

According to an embodiment, said at least one support portion 9, 10 comprises a first support portion 9 and a second support portion 10. According to an embodiment, said first support portion 9 and said second support portion 10 are integrally laterally connected to said connector body 4 by diametrically opposite parts along said lateral direction Z-Z.

According to an embodiment, each support portion 9, 10 comprises a respective connector support surface 11, 12 to be supported against the caliper body 102 so as to block each elastic interference portion 7, 8 bent in said maximum interference configuration and interposed between the respective caliper body surface 108, 109 and the respective support portion 9, 10 when said hook portion 6 is coupled to said tooth 107.

According to an embodiment, each connector support surface 11, 12 comprises at least one support plane incident with a support direction X-X transverse to said lateral direction Z-Z and to a direction parallel to said axial direction A-A.

According to an embodiment, said first elastic interference portion 7 and said second elastic interference portion 8 overhangingly project from said first support portion 9 and said second support portion 10, respectively, along directions parallel to said axial direction A-A by elastically bending about a bending axis parallel to said lateral direction Z-Z.

According to an embodiment, said hook portion 6 is rigid.

According to an embodiment, said hook portion 6 has a coupling edge 22 configured to be coupled to said tooth 107. According to an embodiment, said coupling edge 22 has a counter-shaped profile with respect to the profile of said tooth 107. According to an embodiment, said coupling edge 22 comprises, away from said connector body 4, at least a first hook section 23, a second hook section 24, and a third hook section 25 mutually joined forming a concave hook profile. According to an embodiment, said hook third section 25 is a free end of the hook portion 6.

According to an embodiment, said first hook section 23 is inclined by a first angle, with respect to a direction parallel to said axial direction A-A, between 10 and 40 degrees, preferably between 30 and 35 degrees.

According to an embodiment, said second hook section 24 is inclined by a second angle, with respect to said axial direction A-A, between 80 and 120°, preferably between 100 and 110 degrees.

According to an embodiment, said third hook section 25 is inclined by at least 130°, preferably at least 140° with respect to said axial direction A-A.

According to an embodiment, at least said third hook section 25 faces said distal portion 13 of each elastic interference portion 7, 8, where each elastic interference portion 7, 8 rotates toward said third section 25 when switching from said maximum interference configuration to said resting configuration.

According to an embodiment, said third hook section 25 is configured to abut like an undercut with a tooth section.

The present invention also relates to a caliper body 102 for a brake caliper. The caliper body 102 comprises at least one caliper body wall 106 comprising a tooth 107 projecting from the caliper body wall 106, and at least one caliper body surface 108, 109 delimiting said caliper body wall 106 on the side opposite to the tooth 107. The hook portion 6 of the electrical connector 1 is thus couplable to the tooth 107, and at least one elastic interference portion 7, 8 is elastically bendable to block by interference against the caliper body surface 108, 109, by coupling the electrical connector 1 to the caliper body wall 106 between the hook portion 6 and each elastic interference portion 7, 8 avoiding the use of screw fastening systems and/or fixing holes in the caliper body 102 or metal plates.

According to an embodiment, the caliper body wall 106 is free from finishing machining operations, and the at least one caliper body surface 108, 109 has a surface roughness so as to allow the elastic interference portion 7, 8 of the connector 1 to be blocked by interference.

According to an embodiment, said caliper wall 106 defines a self-centering seat having a U-shaped profile delimited by a first wall portion 110, a hollow portion 111, and a second wall portion 112. Said hook portion 6 is thus insertable into said self-centering seat to be coupled to said tooth 107, going with said hook portion 6 in axial direction A-A beyond the caliper body wall, thus guiding laterally the connector body 4 toward the hollow portion 111 with the edge of said first wall portion 110 and the edge of said second wall portion 112 facing each other from opposite sides.

According to an embodiment, said tooth 107 projects from said hollow portion 111, and said caliper body surface 108, 109 comprises a first caliper body surface 108 delimiting the first wall portion 110 on the opposite side with respect to said tooth 107 and a second caliper body surface 109 delimiting the second wall portion 112 on the opposite side with respect to said tooth 107. Said first elastic interference portion 7 and said second elastic interference portion 8 thus slide on said first caliper body surface 108 and said second caliper body surface 109 bending from said resting configuration to said maximum interference configuration by elastically tightening by interference the caliper body wall 106 from diametrically opposite sides along an axial direction A-A relative to which said connector body 4 mainly extends, between said hook portion 6, on the one hand, and said first elastic interference portion 7 and said second elastic interference portion 8 on the other hand.

According to an embodiment, said caliper body 102 is made by melt molding of a metal material, such as cast iron or aluminum.

According to an embodiment, the tooth 107 is crossed by a caliper body separation line 117 defined on the caliper 102 by two half-molds during melt molding.

According to an embodiment, said caliper body 102 comprises, on said tooth 107 along the caliper body separation line 117, a sharp-edged molding burr 122 configured to stick into said hook portion 6 by plastically deforming part of the hook portion 6 directly facing the sharp-edged molding burr 122 thus increasing the coupling between the electrical connector 1 and the caliper body 102.

According to an embodiment, said tooth 107 comprises a tooth coupling edge 118 configured to be coupled by said hook portion 6. According to an embodiment, the tooth coupling edge 118 comprises, by projecting on the opposite side of the caliper body surface 113, 114, at least a first tooth section 119, at least a second tooth section 120, and a third tooth section 121.

According to an embodiment, said first hook section 23 is substantially counter-shaped with respect to said first tooth section 119, said second hook section 24 is substantially counter-shaped with respect to said second tooth section 120, said third hook section 25 is substantially counter-shaped with respect to said third tooth section 121 so that said hook portion 6 is shape-coupled at least partially to said tooth 107.

According to an embodiment, said first tooth section 119 and said third tooth section 120 face at least partially in diametrically opposite directions along the radial direction R-R.

According to an embodiment, said first tooth section 119 and said second tooth section 120 are joined at the caliper body separation line 117.

By virtue of the suggested solutions, it is possible to ensure a reliable connection of the electrical connector to the caliper body, where the hook portion 6 is tightened against the tooth 107 of the caliper body through which the separation line passes, thus ensuring the presence of irregularities in the caliper body which increase the coupling between the electrical connector and the caliper body.

According to an embodiment, said sharp-edged molding burr 122 projects between said first tooth section 119 and said second tooth section 120 along the caliper body separation line 117.

By virtue of the suggested solutions, due to the sharp-edged burr stuck into the connector body at the hook portion directly facing the tooth surface, it is possible to increase the coupling between the electrical connector and the caliper body.

According to an embodiment, said electrical connector 2 is directly and irreversibly coupled by interference to the caliper body 102, in other words, once the electrical connector has been coupled to the caliper body 102 by the interference of the elastic interference portion elastically bent against the caliper body surface and by coupling the hook portion to the tooth, it cannot be separated except by breaking off an end portion of the hook portion.

According to an embodiment, the caliper body 102 comprises at least one caliper body support surface 113, 114 arranged on the side opposite to said tooth 107 and on the same side as said caliper body surface 108, 109, leaving an unobstructed space directly facing at least the end portion of the caliper body surface 108, 109. Therefore, when the connector body 4 is supported on said caliper body support surface 113, 114 with said at least one elastic interference portion 7, 8 in said maximum interference configuration and said hook portion 6 is coupled to said tooth 107, the electrical connector 1 is correctly and stably coupled to said caliper body 102.

According to an embodiment, said caliper body wall 106 mainly extends in a radial direction R-R from the caliper body 102, where said radial direction R-R is orthogonal or incident to the axial direction A-A, and where the radial direction R-R is orthogonal or incident to a lateral direction Z-Z, orthogonal or incident to said axial direction A-A.

According to an embodiment, said tooth 107 is couplable to said hook portion 6 like an undercut in a radially internal position. According to an embodiment, each caliper body 108, 109 is configured to interfere with the respective elastic interference portion 7, 8 in a radially external position. According to an embodiment, said at least one support surface 113, 114 is configured to carry said connector body 4 in a supporting manner in an intermediate position.

According to an embodiment, said intermediate position is arranged along said radial direction R-R or a direction parallel thereto between said internal position and said external position.

According to an embodiment, going along said radial direction R-R from a free edge of said caliper body wall 106, said caliper body wall 102 is tapered by increasing in thickness along said axial direction A-A or a direction parallel thereto.

According to an embodiment, going toward said tooth 107 from the respective upper edges of said first wall portion 110 and said second wall portion 112 along said radial direction R-R, said first wall portion 110 and said second wall portion 112 are tapered at least from the side axially opposite to said tooth 107 increasing in thickness, so that by inserting the hook portion 6 into the self-centering seat and rotating the connector body 4 in the direction opposite to said tooth 107 pushing each elastic interference portion 7, 8 against the respective wall portion 110, 112, each elastic interference portion 7, 8 bends by sliding on the respective caliper body surface 108, 109 until it blocks by interference between the respective caliper body surface 108, 109 and the connector body 4, when the connector body 4 abuts by resting on the at least one support surface 113, 114.

According to an embodiment, said caliper body 102 comprises a first protrusion 115 and a second protrusion 116 which extend from the caliper body 102 mainly along said radial direction R-R tapering and thus reducing the thickness thereof. According to an embodiment, said first protrusion 115 comprises a first caliper body support surface 113 at a radial end thereof. According to an embodiment, said second protrusion 116 comprises a second caliper body support surface 114 at a radial end thereof. Since said connector body 4 comprises a first support portion 9 and a second support portion 10, it is thus supported with a respective connector support surface 11, 12 blocking each elastic interference portion 7, 8 bent in said maximum interference configuration and interposed between the respective caliper body surface 108, 109 and the respective connector support portion 9, 10 when said hook portion 6 is coupled to said tooth 107.

The present invention also relates to a brake caliper assembly 100, comprising an electrical connector 1 according to any one of the previously described embodiments, and a caliper body 102 according to any one of the previously described embodiments, where said electrical connector 1 is coupled to said caliper body 102.

According to an embodiment, said caliper body 102 is a caliper body of a brake caliper of the floating type. According to an embodiment, the brake caliper comprises a caliper body 102 according to one of the previously described embodiments, and a support bracket 101, where the caliper body 102 is adapted to be arranged to straddle a brake disc and where the caliper body 106 is adapted to float, i.e., translate or slide axially with respect to the support bracket 101 along an axial direction A-A parallel to the direction of the brake disc axis. According to an embodiment, the caliper body 106 internally comprises pad seats 104 on opposite sides to house respective opposing brake pads 103, so that thrust means housed in the caliper body act directly on a first pad 103 and the floating motion of the caliper body 106 also applies a corresponding thrust action on the second pad. According to an embodiment, said brake caliper comprises at least one pad return spring 105 to move the brake pads 103 away from the brake disc once the braking action is complete.

The present invention also relates to a wear indicator comprising an electrical connector 1 according to any one of the previously described embodiments and a wear sensor 2 electrically connected to the electrical connector 1 by means of an electrical cable 3, where the wear sensor is connectable to a brake pad 103.

By virtue of the suggested solutions, it is possible to reduce the number of elements required to connect an electrical connector to the caliper body, avoiding the use of sheared and bent elastic metal plates by directly coupling the connector body 4 to the caliper body 106.

### LIST OF REFERENCE SIGNS

1 electrical connector
2 wear sensor
3 electrical cable
4 insulating material body or connector body
5 seat for plug or socket
6 hook portion
7 first elastic interference portion
8 second elastic interference portion
9 first support portion
10 second support portion
11 first connector support surface
12 second connector support surface
13 distal portion
14 proximal portion
15 central portion
16 abutment portion
17 counter-abutment portion
18 first sliding section
19 second sliding section
20 sharp portion
21 wear sensor side connection end
22 coupling edge
23 first hook section
24 second hook section
25 third hook section
26 flat spring
100 caliper assembly
101 support bracket
102 caliper body
103 brake pads
104 pad seats
105 pad spring
106 caliper body wall
107 tooth
108 first caliper body surface
109 second caliper body surface
110 first wall portion
111 hollow portion
112 second wall portion
113 first caliper body support surface
114 second caliper body support surface
115 first protrusion
116 second protrusion
117 separation line
118 tooth coupling edge
119 first tooth section
120 second tooth section
121 third tooth section
122 sharp-edged molding burr
A-A axial direction
Z-Z lateral direction
R-R radial direction

1-15. (canceled)

16. An electrical connector for a wear sensor, comprising a connector body made of an electrically insulating material and defining a seat for a plug or a socket for electrically connecting the wear sensor to a wear detection circuit, wherein
the electrical connector comprises
a hook portion in a shape of a hook, wherein said hook portion is configured to be coupled to a tooth of a caliper body, wherein the hook portion is made in one piece with said connector body, and
at least one elastic interference portion overhangingly projecting from the connector body, and wherein
each elastic interference portion is elastically bendable between a resting configuration and a maximum interference configuration so as to slide against a caliper body surface opposite to said tooth by bending from said resting configuration until it blocks by interference against the caliper body surface in said maximum interference configuration by tightening a caliper body wall of the caliper body from opposite sides between the hook portion and each elastic interference portion.

17. The electrical connector of claim 16, wherein
the electrical connector comprises at least one support portion made in one piece with said connector body, wherein said at least one elastic interference portion overhangingly projects from said at least one support portion, and
wherein said at least one support portion comprises a preferably flat connector support surface to be supported against the caliper body to block each elastic interference portion bent in said maximum interference configuration and interposed between said caliper body surface and said support portion.

18. The electrical connector of claim 16, comprising at least one of the following features or a combination thereof:
each elastic interference portion is made in one piece with said connector body,
each elastic interference portion is made by molding a polymer material,
said connector body is made of polyamide.

19. The electrical connector of claim 18, wherein said polyamide is nylon 66 or polyamide 66.

20. The electrical connector of claim 16, wherein each elastic interference portion comprises:
a distal portion adapted to slide on said caliper body surface until the distal portion blocks on said caliper body surface when said elastic interference portion is in said maximum interference configuration,
a proximal portion connected to said connector body, and
a central portion joined to said distal portion and said proximal portion, wherein said central portion is U-or V-shaped defining a fulcrum about which said distal portion elastically rotates with respect to said proximal portion between said resting configuration and said maximum interference configuration.

21. The electrical connector of claim 20, comprising at least one of the following features or a combination thereof:
each elastic interference portion comprises an abutment portion joining the central portion and the distal portion, and a counter-abutment portion joining the central portion and the proximal portion,
said abutment portion faces said counter-abutment portion,
the distal portion is configured to elastically rotate about the central portion until the abutment portion abuts against the counter-abutment portion preventing further elastic rotations of the distal portion with respect to the proximal portion,
said abutment portion and said counter-abutment portion respectively comprise an abutment surface and a counter-abutment surface, wherein
in said resting configuration the abutment surface and the counter-abutment surface are oriented with respect to each other by an angle between 45 and 20 degrees, and
in said maximum interference configuration said abutment surface and said counter-abutment surface are in contact in at least one point and/or are oriented parallel to each other,
between said resting configuration and said maximum interference configuration, each distal portion rotates with respect to a respective proximal portion by an interference angle between 45 degrees and 20 degrees,
each distal portion has a convex profile to facilitate sliding against the caliper body surface by rotating the distal portion about the central portion,
each distal portion has at least a first sliding section joined to a second sliding section by a sharp portion configured to tighten by interference on the caliper body surface.

22. The electrical connector of claim 21, wherein, in said resting configuration, the abutment surface and the counter-abutment surface are oriented with respect to each other by an angle between 40 and 35 degrees.

23. The electrical connector of claim 21, wherein, between said resting configuration and said maximum interference configuration, each distal portion rotates with respect to the respective proximal portion by an interference angle between 40 degrees and 35 degrees.

24. The electrical connector of claim 16, wherein
said connector body mainly extends along an extension axis, defining an axial direction, between a wear sensor side connection end and said seat for the plug or the socket for electrically connecting the wear sensor to the wear detection circuit, wherein
each elastic interference portion mainly extends along a direction parallel to said axial direction, wherein
said at least one elastic interference portion comprises a first elastic interference portion and a second elastic interference portion laterally connected to said connector body by two diametrically opposite parts of the connector body along a lateral direction orthogonal and/or incident to said axial direction, and wherein
said first elastic interference portion and said second elastic interference portion overhangingly project from said connector body along directions parallel to said extension axis by elastically bending about a bending axis parallel to said lateral direction.

25. The electrical connector of claim 24, further comprising at least one support portion made in one piece with said connector body and comprising a first support portion and a second support portion, wherein
said first support portion and said second support portion are integrally laterally connected to said connector body by diametrically opposite parts along said lateral direction, wherein
each support portion comprises a respective connector support surface to be supported against the caliper body to block each elastic interference portion bent in said maximum interference configuration and interposed between the respective caliper body surface and the respective support portion when said hook portion is coupled to said tooth, each connector support surface comprising at least one support plane incident with a support direction transverse to said lateral direction and to a direction parallel to said axial direction, and wherein
said first elastic interference portion and said second elastic interference portion overhangingly project from said first support portion and said second support portion, respectively, along directions parallel to said axial direction by elastically bending about the bending axis parallel to said lateral direction.

26. The electrical connector of claim 16, wherein said hook portion extends along an axial direction at least partially beyond a wear sensor side end of the connector body, and wherein the electrical connector comprises at least one of the following features:
said hook portion is rigid,
said hook portion has a coupling edge configured to be coupled to said tooth,
said hook portion has a coupling edge having a counter-shaped profile with respect to a profile of said tooth,
said hook portion has a coupling edge comprising, away from said connector body, at least a first hook section, a second hook section, and a third hook section mutually joined forming a concave hook profile,
said hook portion has a coupling edge comprising a first hook section inclined by a first angle with respect to a direction parallel to said axial direction between 10 degrees and 35 degrees, a second hook section inclined by a second angle with respect to said axial direction, or a direction parallel thereto, between 80 degrees and 120 degrees, and a third hook section inclined by a third angle with respect to said axial direction, or a direction parallel thereto, of at least 130 degrees,
at least said third hook section faces a distal portion of each elastic interference portion, each elastic interference portion rotating toward said third hook section when switching from said maximum interference configuration to said resting configuration,
said third hook section is configured to abut like an undercut with a tooth section.

27. The electrical connector of claim 16, further comprising a flat spring, wherein said flat spring comprises said at least one elastic interference portion, wherein said flat spring is connected, optionally by interlocking or co-molding, to the connector body so that the at least one elastic interference portion overhangingly projects from the connector body to tighten the caliper body wall of the caliper body from the opposite sides between the hook portion and each elastic interference portion.

28. A caliper body for a brake caliper, comprising:
at least one caliper body wall comprising a tooth projecting from the caliper body wall, and
at least one caliper body surface delimiting said caliper body wall on an opposite side of the tooth,
so that an electrical connector, comprising a hook portion couplable to the tooth and at least one elastic interference portion elastically bendable to block an interference against the at least one caliper body surface, is coupled to the caliper body wall between the hook portion and each elastic interference portion avoiding screw fastening systems and/or fixing holes in the caliper body.

29. The caliper body of claim 28, wherein
said caliper body wall defines a self-centering seat having a U-shaped profile delimited by a first wall portion, a hollow portion, and a second wall portion, wherein
said tooth projects from said hollow portion, and said at least one caliper body surface comprises a first caliper body surface delimiting the first wall portion on the opposite side of said tooth and a second caliper body surface delimiting the second wall portion on the opposite side of said tooth,
so that said hook portion is insertable into said self-centering seat to be coupled to said tooth,
said elastic interference portion comprising a first elastic interference portion and a second elastic interference portion laterally connected to a connector body by two diametrically opposite parts of the connector body, and wherein
said first elastic interference portion and said second elastic interference portion slide on said first caliper body surface and said second caliper body surface bending from a resting configuration to a maximum interference configuration by elastically tightening by interference the caliper body wall from diametrically opposite sides along an axial direction relative to which said connector body mainly extends, between said hook portion, on the one hand, and said first elastic interference portion and said second elastic interference portion, on the other hand.

30. The caliper body of claim 28, comprising at least one of the following features or a combination thereof:
said caliper body is made by molding, of cast iron or aluminum metal material,
the tooth is crossed by a caliper body separation line defined on the caliper body by two half-molds during melt molding,
said caliper body comprises on said tooth, along the caliper body separation line, a sharp-edged molding burr configured to stick into said hook portion by plastically deforming part of the hook portion directly facing the sharp-edged molding burr, increasing a coupling between the electrical connector and the caliper body.

31. The caliper body of claim 28, comprising at least one of the following features or a combination thereof:
said tooth comprises a tooth coupling edge configured to be coupled by said hook portion,
the tooth coupling edge comprises, projecting on an opposite side of the caliper body surface, at least a first tooth section, at least a second tooth section, and a third tooth section,
a first hook section is substantially counter-shaped with respect to said first tooth section, a second hook section is substantially counter-shaped with respect to said second tooth section, and a third hook section is substantially counter-shaped with respect to said third tooth section so that said hook portion is shape-coupled at least partially to said tooth,
said first tooth section and said third tooth section face at least partially in diametrically opposite directions along a radial direction,
said first tooth section and said second tooth section are joined at a caliper body separation line,
a sharp-edged molding burr projects between said first tooth section and said second tooth section along the caliper body separation line.

32. The caliper body of claim 28, comprising at least one of the following features or a combination thereof:
said caliper body comprises at least one caliper body support surface arranged on the opposite side of said tooth and on a same side as said caliper body surface, so that a connector body is supported on said at least one caliper body support surface when said at least one elastic interference portion is in a maximum interference configuration and said hook portion is coupled to said tooth,
said caliper body wall mainly extends in a radial direction from the caliper body, wherein said radial direction is orthogonal or incident to the axial direction, and wherein the radial direction is orthogonal or incident to a lateral direction, orthogonal or incident to said axial direction,
said tooth is couplable to said hook portion like an undercut in a radially internal position,
each caliper body surface is configured to interfere with a respective elastic interference portion in a radially external position,
said at least one caliper body support surface is configured to bear in a supporting manner said connector body in an intermediate position, wherein
said intermediate position is arranged along said radial direction or a direction parallel thereto between said internal position and said radially external position,
said caliper body comprises a first protrusion and a second protrusion extending from the caliper body mainly along said radial direction, tapering and reducing a thickness thereof, wherein said first protrusion comprises a first caliper body support surface at a radial end thereof, and said second protrusion comprises a second caliper body support surface at a radial end thereof, so that said connector body, comprising a first support portion and a second support portion, is supported with a respective connector support surface blocking each elastic interference portion bent in said maximum interference configuration and interposed between the respective caliper body surface and the respective support portion when said hook portion is coupled to said tooth.

33. A brake caliper assembly, comprising:
an electrical connector comprising a connector body made of an electrically insulating material and defining a seat for a plug or a socket for electrically connecting the wear sensor to a wear detection circuit, wherein
the electrical connector comprises
a hook portion in a shape of a hook, wherein said hook portion is configured to be coupled to a tooth of a caliper body, wherein the hook portion is made in one piece with said connector body, and
at least one elastic interference portion overhangingly projecting from the connector body, and wherein
each elastic interference portion is elastically bendable between a resting configuration and a maximum interference configuration so as to slide against a caliper body surface opposite to said tooth by bending from said resting configuration until it blocks by interference against the caliper body surface in said maximum interference configuration by tightening a caliper body wall of the caliper body from opposite sides between the hook portion and each elastic interference portion, and
the caliper body of claim 28, wherein said electrical connector is coupled to said caliper body.

34. A wear indicator for a disc brake, comprising:
the electrical connector of claim 16, and
a wear sensor electrically connected to said electrical connector by at least one electrical cable, wherein said wear sensor is connectable to a brake pad.
